(19) United States
(12) Patent Application Publication
(10) Pub. No.: US 2012/0036525 A1
(43) Pub. Date: Feb. 9, 2012

(54) UNIFIED USER INTERFACE FOR VIEWING DESIRED MULTI-MEDIA CONTENT ON AN INTERNET TELEVISION

(76) Inventors: Satish Mugulavalli, Bangalore (IN); Vijay Maheshwari, (US); Huzefa Saifee, Bangalore (IN)

(21) Appl. No.: 13/192,486

(22) Filed: Jul. 28, 2011

Related U.S. Application Data
(60) Provisional application No. 61/370,460, filed on Aug. 4, 2010.

(51) Int. Cl. H04N 7/167

(52) U.S. Cl. 725/31

(57) ABSTRACT

A unified user interface for viewing desired multi-media content received from one or more digital media devices and one or more Internet devices on an Internet television (TV) is disclosed. In one embodiment, a raw uncompressed media data is generated from multi-media streams received from the Internet devices. Further, decrypted digital media content is substantially simultaneously generated from received encrypted digital media content received from the digital media devices. Furthermore, mixed multi-media content is generated by processing the raw uncompressed media data and the decrypted digital media content. In addition, any one of the raw uncompressed media data, the decrypted digital media content and the mixed multi-media content is encrypted and transmitted to the Internet TV through a digital media receiver interface. The raw uncompressed media data and decrypted digital media content in the mixed multi-media content are displayed on different portions of a display of the Internet TV.

This application claims priority under 35 U.S.C 119(e) to U.S. Provisional Application No. 61/370,460 entitled “Unified user interface for viewing desired media content on an internet television” by Satish Mugulavalli et al. filed on Aug. 4, 2010, which is incorporated herein by reference.

### BACKGROUND

Internet television (TV) is rapidly creating an alternative way of accessing the Internet. TV viewers, demanding entertainment and informational resources beyond cable broadcasting and video cassettes, are discovering that the Internet TV satisfies this need. The Internet TV offers technology that takes advantage of packet-switched information in the form of web pages available from wide-area networks (WANs) in hyper-text markup language (HTML) or moving picture experts group (MPEG) formats.

The Internet TV seems to appeal many consumers as it is typically less expensive and can require less technical sophistication than standard methods of accessing the Internet through a personal computer (PC). Integration of Internet access resources with a TV receiver is more convenient than relying on the PC. Many potential users of the Internet who do not possess PCs, or who are intimidated by the perceived technical skill involved in operating the PC, but who desire to use various Internet services (e.g., e-mail), are otherwise eliminated from this market.

Generally, the Internet TV does not require complicated PC hardware and software such as a separate browser, a separate monitor and a computer keyboard to access the Internet. Typically, all accessing functions are performed within an Internet TV set-top box coupled to the Internet TV. The Internet TV set-top box is generally connected directly to the Internet TV, and a remote control device typically controls the Internet TV set-top box with signals transmitted in infrared (IR) or radio frequency bands. Memory required within the Internet TV set-top box is typically less than what is required for the PC. Further, a dedicated operating system for a processor in the Internet TV set-top box is greatly simplified when compared to that of the PC. Furthermore, a user may not have to purchase a separate video monitor, thereby reducing the number of required devices and consequent expenses required for accessing the Internet TV.

Currently, the Internet TV set-top box is not setup to receive and provide digital media content coming from digital media devices, such as a digital video disc (DVD) player, a playstation, a cable TV set-top box, a satellite TV set-top box and the like along with multi-media stream received via the Internet to the Internet TV. Further, for accessing the digital media content, the user may have to disconnect the Internet TV set-top box from the Internet TV and then connect to the digital media device(s) for viewing the digital media content. For example, if the DVD player is connected to the Internet TV, the Internet TV can display only the digital media content coming from the DVD player. If the user desires to watch a cable channel program, the user has to disconnect the DVD player and then connect the cable TV set-top box to the Internet TV for viewing the cable channel program. This may restrict the user from viewing the desired content as it requires the user to connect and disconnect devices to the Internet TV.

Another problem with the Internet TV is that, it may fail to display multi-media content from different devices simultaneously without the multi-media content being overlapped. Typically, overlapping of the multi- media content displayed on the Internet TV may result in violation of broadcast TV regulations.

### BRIEF DESCRIPTION OF THE DRAWINGS

Various embodiments are described herein with reference to the drawings, wherein:

FIG. 1 illustrates a block diagram showing a device coupled to an Internet television (TV) for broadcasting multi-media content received from one or more Internet devices and one or more digital media devices, according to one embodiment;

FIG. 2 illustrates an exploded view of the device, such as the one shown in FIG. 1, according to one embodiment;

FIG. 3 illustrates a process flowchart of delivering the multi-media content to the Internet TV, according to one embodiment;

FIG. 4 illustrates a block diagram showing the device, such as the one shown in FIG. 2, inside the Internet TV for broadcasting the multi-media content received from the one or more Internet devices and the one or more digital media devices, according to one embodiment;

FIG. 5 illustrates a screenshot showing a homepage view displayed on the Internet TV, according to one embodiment;

FIGS. 6A-6E illustrate screenshots showing accessing of various devices connected to the Internet TV via the device, such as the one shown in FIG. 2, according to one embodiment;

FIGS. 7A-7I illustrate screenshots showing accessing of main menu and sub-menu of the homepage without overlapping the multi-media content, according to one embodiment;

FIGS. 8A-8C illustrate screenshots showing accessing of a community network while a program is running, according to one embodiment; and

FIGS. 9A-9C illustrate screenshots showing playing of customized multi-media content when advertisements are being broadcasted, according to one embodiment.

The drawings described herein are for illustration purposes only and are not intended to limit the scope of the present disclosure in any way.

### DETAILED DESCRIPTION

A unified user interface for viewing desired multi-media content on an Internet television (TV) is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

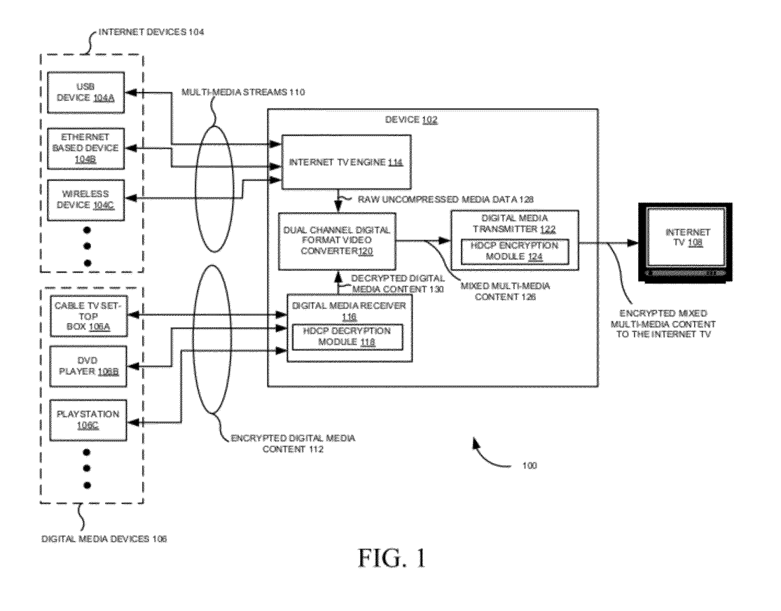

FIG. 1 illustrates a block diagram 100 showing a device 102 coupled to the Internet TV 108 for broadcasting the multi-media content received from one or more Internet devices 104 and one or more digital media devices 106, according to one embodiment. As shown in FIG. 1, the one or more Internet devices 104 and the one or more digital media devices 106 are communicatively coupled to the device 102 via input ports for providing inputs to the device 102. Exemplary input ports of the device 102 include an universal serial bus (USB) port, an Ethernet port, a digital media receiver port and the like. The inputs to the device 102 includes multi-media streams 110 and encrypted digital media content 112 obtained from the Internet devices 104 and the digital media devices 106, respectively. The encrypted digital media content 112 is having a resolution of 480 progressive scan (p), 720 p and 1080 p. Exemplary Internet devices 104 include a USB device 104A, an Ethernet based device 104B, a wireless device 104C and the like. Exemplary digital media devices 106 include a cable TV set-top box 106A, a digital video disk (DVD) player 106B, a playstation 106C and the like.

Further as shown in FIG. 1, the output of the device 102 is communicatively coupled to the Internet TV 108 via an output port for displaying the multi-media content received from any one of the Internet devices 104 and the digital media devices 106 on a display of the Internet TV 108 based on a user request. In one embodiment, the device 102 connects the display of the Internet TV 108 to the Internet devices 104 and/or the digital media devices 106 based on the user request.

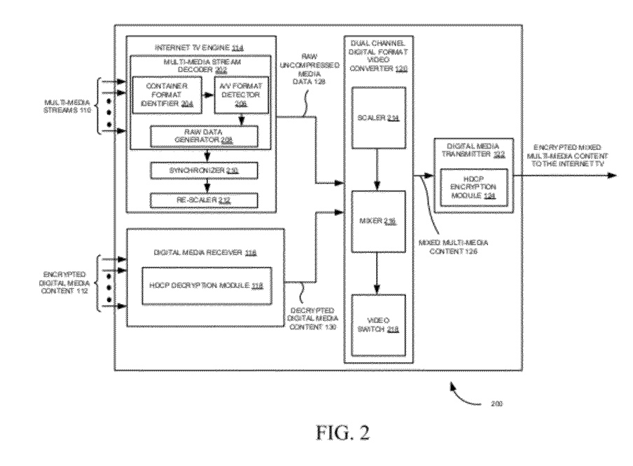

Furthermore as shown in FIG. 1, the device 102 includes an Internet TV engine 114, a digital media receiver 116 including a high-bandwidth digital content protection (HDCP) decryption module 118, a dual channel digital format video converter 120 and a digital media transmitter 122 including a HDCP encryption module 124. The operation of the device 102 is described in greater detail with reference to FIG. 2.

Referring now to FIG. 2, an exploded view of the device 102, such as the one shown in FIG. 1 is illustrated, according to one embodiment. As shown in FIG. 2, the device 102 includes the Internet TV engine 114, the digital media receiver 116 including the HDCP decryption module 118, the dual channel digital format video converter 120, and the digital media transmitter 122 including the HDCP encryption module 124. Further as shown in FIG. 2, the Internet TV engine 114 and the digital media receiver 116 are coupled to the dual channel digital format video converter 120. Furthermore, the dual channel digital format video converter 120 is coupled to the digital media transmitter 122.

In addition as shown in FIG. 2, the Internet TV engine 114 includes a multi-media stream decoder 202 coupled to a synchronizer 210 which is further coupled to a re-scaler 212. The multi-media stream decoder 202 further includes a container format identifier 204 coupled to an audio-video (A/V) format detector 206 which is inturn coupled to a raw data generator 208. Also as shown in FIG. 2, the dual channel digital format video converter 120 includes a scaler 214 coupled to a mixer 216 which is further coupled to a video switch 218.

In operation, the Internet TV engine 114 receives the multi-media streams 110 (e.g., audio, video, photo, etc.) from the Internet devices 104, shown in FIG. 1, and generates raw uncompressed media data 128. In one embodiment, the multi-media stream decoder 202 in the Internet TV engine 114 decodes the multi-media streams 110 received by the Internet TV engine 114 via the input ports. Further, the container format identifier 204 identifies a container format of the received multi-media streams 110 (i.e. whether the received multi-media streams 110 include audio stream, video stream or A/V stream) by parsing the multi-media streams 110. The container format identifier 204 then separates the multi-media streams 110 into three categories such as audio streams, video streams and A/V streams.

Furthermore, the A/V format detector 206 detects A/V format (e.g., of audio streams, video streams or A/V streams) associated with the identified container format of the received multi-media streams 110. Also, the A/V format detector 206 loads at least one of audio decoders, video decoders and A/V decoders based on the detected A/V format. In addition, the raw data generator 208 decodes each of the received audio streams, video streams and A/V streams using the loaded at least one of the audio decoders, video decoders and/or A/V decoders and generates decoded multi-media streams using the decoded audio streams, video streams and A/V streams.

Further in this embodiment, the synchronizer 210 synchronizes the decoded multi-media streams based on time stamps. Furthermore, the re-scaler 212 re-scales resolutions of the synchronized decoded multi-media streams (as different multi-media streams have different resolutions (e.g., width and height of the multi-media streams)) to a same resolution and generates the raw uncompressed media data 128. In addition, the re-scaler 212 transmits the raw uncompressed media data 128 to the dual channel digital format video converter 120.

Further in operation, the digital media receiver 116 receives the encrypted digital media content 112 from the digital media devices 106, shown in FIG. 1, connected via an analog interface (composite or s-video) or digital media port and substantially simultaneously generates decrypted digital media content 130. In one embodiment, the HDCP decryption module 118 decrypts the received encrypted digital media content using decryption techniques well known in the art. Further in this embodiment, the digital media receiver 116 transmits the decrypted digital media content 130 to the dual channel digital format video converter 120.

Furthermore in operation, the dual channel digital format video converter 120 receives inputs (e.g., the raw uncompressed media data 128 and the decrypted digital media content 130) from the Internet TV engine 114 and the digital media receiver 116, respectively. In one embodiment, the scaler 214 in the dual channel digital format video converter 120 re-scales each of the received inputs to generate multi-media content of same resolution. The resolutions of the raw uncompressed media data and the decrypted digital media content are scaled by the scaler 214 to resolution in a predetermined range or a fixed resolution. Further, the mixer 216 generates mixed multi-media content 126 by mixing the raw uncompressed media data 128 and the decrypted digital media content 130. Furthermore, the video switch 218 of the dual channel digital format video converter 120 enables switching between the raw uncompressed media data, the decrypted digital media content and the mixed multi-media content based on the request from the user of the Internet TV 108, shown in FIG. 1. In addition, the user request is received via a remote control device of the Internet TV 108, shown in FIG. 1.

In an example embodiment, the dual channel digital format video converter 120 outputs the raw uncompressed media data 128 to the digital media transmitter 122. For example, the dual channel digital format video converter 120 outputs the decrypted digital media content 130 to the digital media transmitter 122. In another example, the dual channel digital format video converter 120 mixes the outputs of the Internet TV engine 114 and the digital media receiver 116 using the mixer 216 and outputs the mixed multi-media content 126 to the digital media transmitter 122 (that may occupy different portions of the display of the Internet TV 108).

In addition in operation, the digital media transmitter 122 receives any one of the raw uncompressed media data 128, the decrypted digital media content 130 and the mixed multi-media content 126 from the dual channel digital format video converter 120. In one embodiment, the HDCP encryption module 124 in the digital media transmitter 122 encrypts the received one of the raw uncompressed media data 128, the decrypted digital media content 130 and the mixed multi-media content 126 and transmits any one of encrypted raw uncompressed media data, encrypted digital media content and encrypted mixed multi-media content to the Internet TV 108 through a digital media receiver interface.

In one embodiment, the encrypted raw uncompressed media data may be a user interface screen from the Internet TV engine 114. In another embodiment, the encrypted raw uncompressed media data may be a video playback screen from the Internet TV engine 114. In yet another embodiment, the encrypted raw uncompressed media data may be the user interface screen from the Internet TV engine 114 combined with the video playback screen from the Internet TV engine 114.

In a further embodiment, the encrypted digital media content may be the video playback screen from the digital media receiver 116. In yet another embodiment, the encrypted mixed multi-media content may be the user interface screen from the Internet TV engine 114 combined with the video playback screen from the digital media receiver 116. The user interface screen and the video playback screen may occupy different portions of the display of the Internet TV 108.

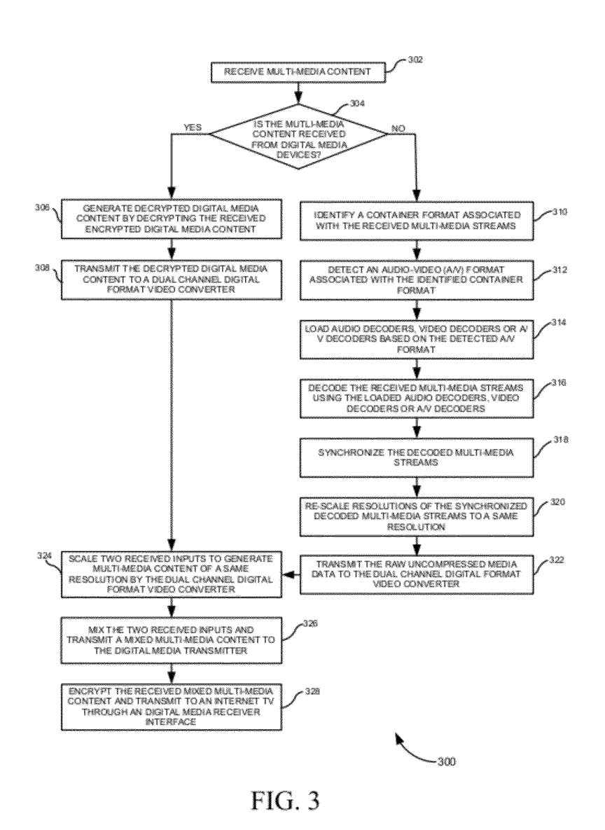

Referring now to FIG. 3, a flowchart 300 illustrates a process of delivering multi-media content to an Internet TV, according to one embodiment. In step 302, the multi-media content (e.g., audio, video, photo, etc.) is received from one of digital media devices, such as a DVD player, an Internet TV set-top box, a playstation and the like or from one of Internet devices, such as an USB device, an Ethernet based device, a wireless device and the like. In step 304, it is determined whether the multi-media content is received from one of the digital media devices. If it is determined that the multi-media content is received from one of the digital media devices, then it implies that the received multi-media content is an encrypted digital media content and thus step 306 is performed. In step 306, the encrypted digital media content is decrypted using decryption techniques known in the art. In step 308, the decrypted digital media content is transmitted to a dual channel digital format video converter.

If the multi-media content is not received from one of the digital media devices, then it implies that the received multi-media content is multi-media streams and thus step 310 is performed. In step 310, the multi-media streams are parsed to identify a container format associated with the received multi-media streams. In step 312, A/V format associated with the identified container format is detected. In step 314, at least one of audio decoders, video decoders, or A/V decoders are loaded based on the detected A/V format. In step 316, the received multi-media streams are decoded using the loaded at least one of audio decoders, video decoders or the A/V decoders. In step 318, the decoded multi-media streams are synchronized based on time stamps.

In step 320, resolutions of the synchronized decoded multi-media streams are re-scaled to a same resolution as the synchronized decoded multi-media streams may have different resolutions. In step 322, the raw uncompressed media data is transmitted to the dual channel digital format video converter.

In step 324, the two received inputs (e.g., the raw uncompressed media data and the decrypted digital media content) are scaled to generate multi-media content of same resolution by the dual channel digital format video converter. In step 326, the two received inputs are mixed and a mixed multi-media content (that may occupy different portions of a display of the Internet TV) is transmitted to a digital media transmitter. In step 328, the received mixed multi-media content is encrypted and transmitted to the Internet TV through a digital media receiver interface such that the raw uncompressed media data and the decrypted digital media content in the mixed multi-media content are displayed on the display of the Internet TV.

In one embodiment, the dual channel digital format video converter generates the raw uncompressed media data and transmits the raw uncompressed media data to the digital media transmitter based on the user preferences. In another embodiment, the dual channel digital format video converter generates the decrypted digital media content and transmits the decrypted digital media content to the digital media transmitter based on the user preferences.

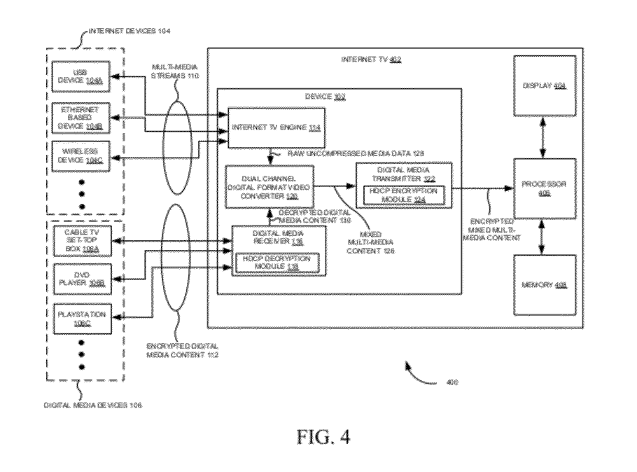

Referring now to FIG. 4, a block diagram 400 showing the device 102 inside an Internet TV 402 for broadcasting the multi-media content received from the one or more Internet devices 104 and the one or more digital media devices 106 is illustrated, according to one embodiment. As shown in FIG. 4, the Internet TV 402 includes the device 102, a display 404, a processor 406 and memory 408. Further as shown in FIG. 4, the device 102 is coupled to the processor 406. Furthermore as shown in FIG. 4, the display 404 and the memory 408 are coupled to the processor 406. The functionality of the device 102 is same as described with reference to FIGS. 1 and 2.

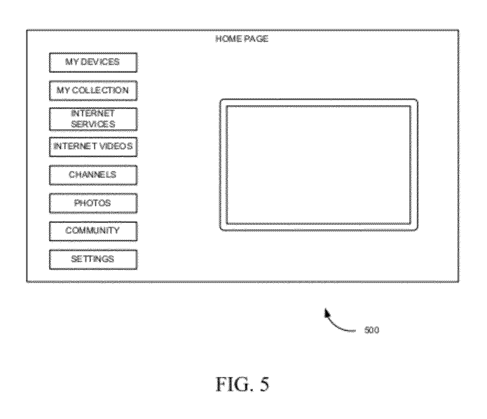

Referring now to FIG. 5, a screenshot 500 showing a homepage view displayed on the Internet TV 108 and Internet TV 402 shown in FIG. 1 and FIG. 4, respectively, is illustrated, according to one embodiment. As shown in FIG. 5, the screenshot 500 shows the homepage view displaying a “my devices” tab, a “my collection” tab, a “Internet services” tab, an “Internet videos” tab, a “channels” tab, a “photos” tab, a “community” tab and a “settings” tab. It is appreciated that, the present invention enables the user to access multi-media content, connect to people and change the settings by selecting the above mentioned tabs. The details of the above mentioned tabs are described in greater detail in the description that follows. Hereinafter, Internet TV refers to the Internet TV 108, shown in FIG. 1 and the Internet TV 402, shown in FIG. 4.

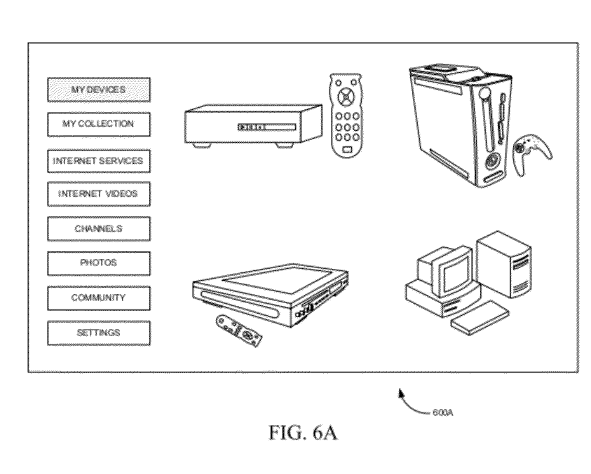

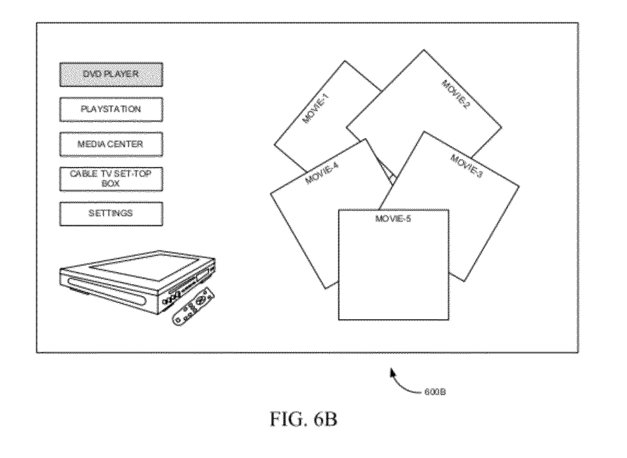

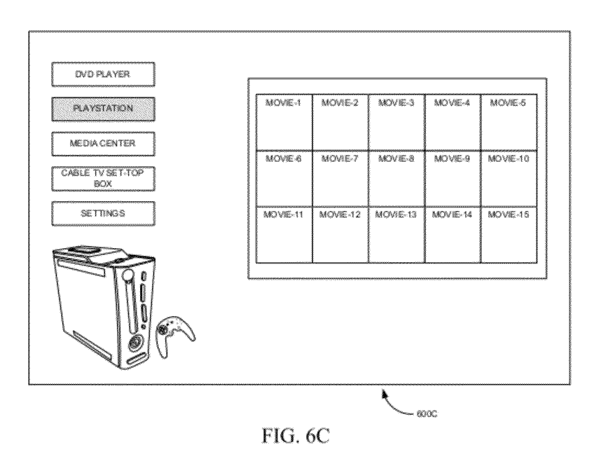

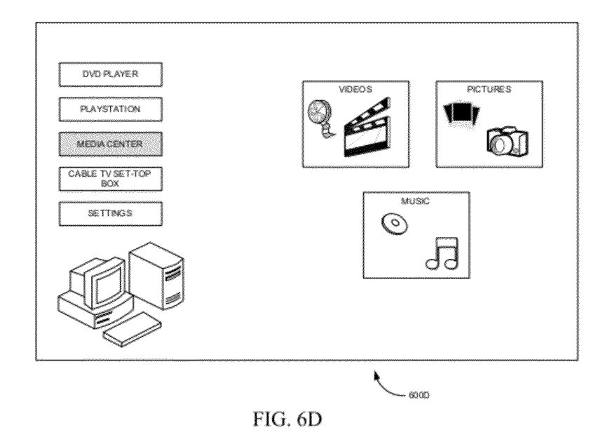

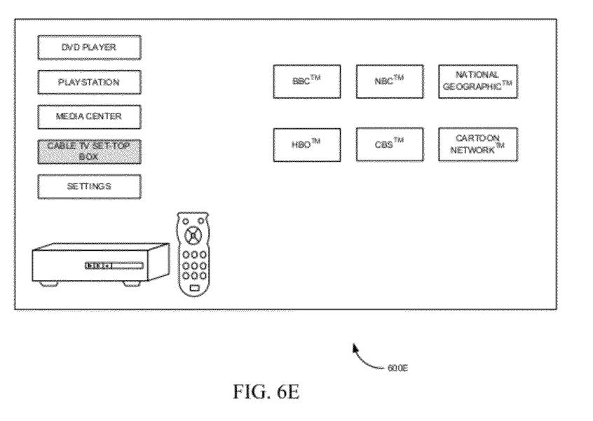

Referring now to FIGS. 6A-6E, screenshots 600A-E showing accessing of various devices connected to the Internet TV via the device 102, such as the one shown in FIG. 2, is illustrated, according to one embodiment. Particularly, FIG. 6A shows the various devices (e.g., media sources) connected to the Internet TV. It is appreciated that the various devices connected to the Internet TV are displayed when the user clicks on the “my devices” tab, as illustrated in FIG. 6A. It can be seen from FIGS. 6B-6E that, a DVD player, a playstation, a media center and a cable TV set-top box are the devices connected to the Internet TV via the device 102. One skilled in the art can envision that multi-media content associated with the various devices can be accessed using the device 102. In one embodiment, the user is allowed to select any one of the connected devices for accessing the multi-media content. Accordingly, the device 102 connects the display of the Internet TV to any one of the connected devices selected by the user.

As shown in FIG. 6B, the Internet TV displays multi-media content (e.g., movie-1, movie-2 and so on) menu for accessing digital media content using the DVD player upon selection of “DVD player” tab by the user. In one embodiment, when the user selects the “DVD player” tab, the device 102 enables the display of the Internet TV to connect to the DVD player coupled to the device 102. FIG. 6C illustrates displaying of a multi-media content (e.g., movie-1, movie-2 and so on) menu that can be accessed using the playstation coupled the device 102 when the user selects a “playstation” tab. In one embodiment, selection of the “playstation” tab enables the display of the Internet TV to connect to the playstation via the device 102.

Similarly, in FIG. 6D and FIG. 6E the Internet TV displays multi-media content menus associated with the media center and the cable TV set-top box when the user selects a “media center” tab and a “cable TV set-top box” tab, respectively. As shown in FIG. 6D, the multi-media content menu includes videos, pictures and music. As shown in FIG. 6E, the multi-media content menu includes BBC™, NBC™, national geographic™, HBO™, CBS™ and cartoon network™. Based on the selection, the device 102 connects the display of the Internet TV to the network attached storage (NAS) and other multimedia PC's or the cable TV set-top box. It is appreciated that, the user is enabled to select desired multi-media content using the multi-media content menu displayed on the Internet TV. Further, the user can select the multi-media content from the multi-media content menu using up, down, left and right keys of the remote control device of the Internet TV.

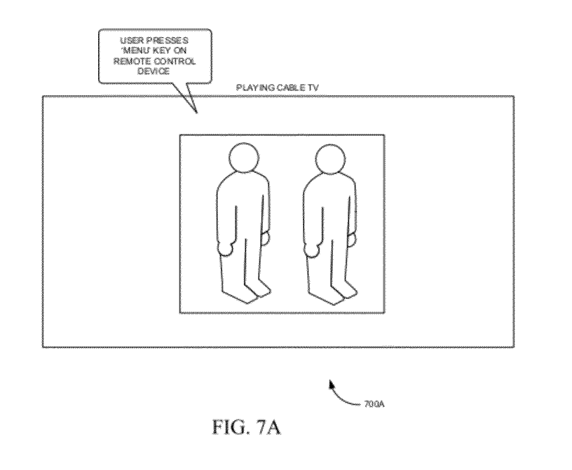

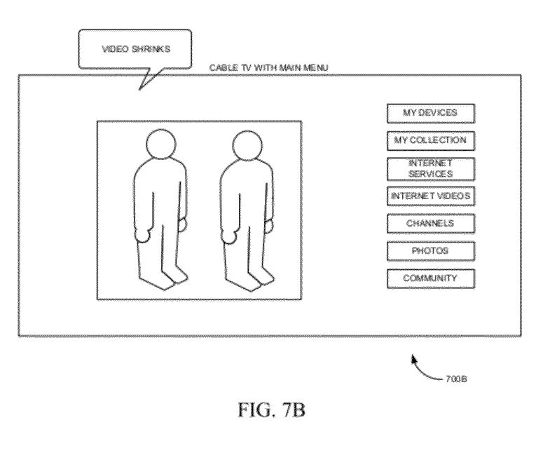

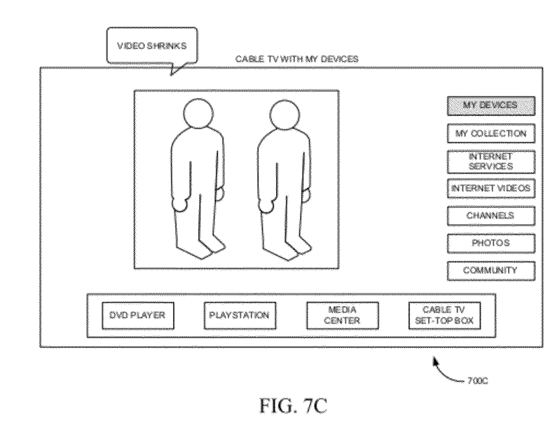

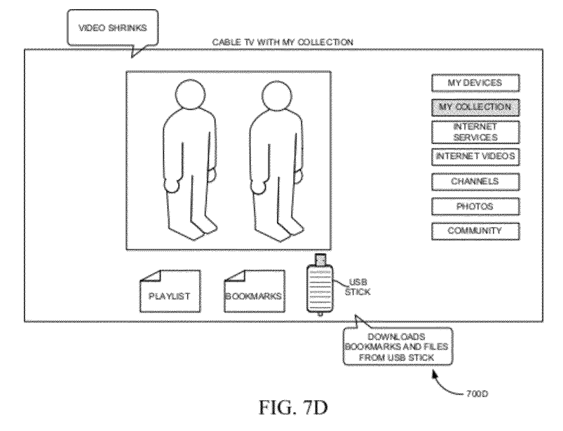

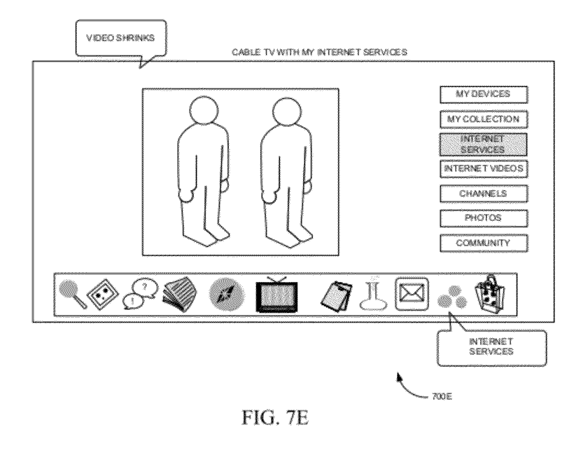

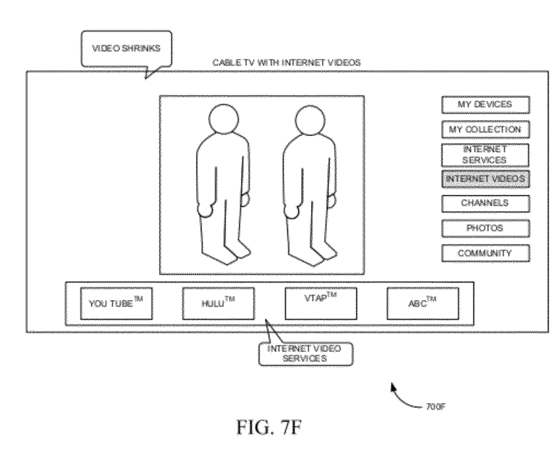

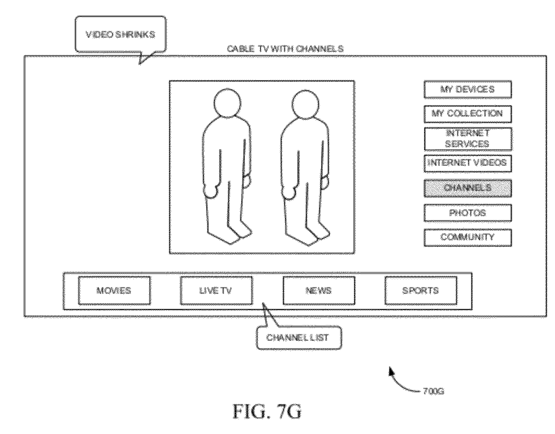

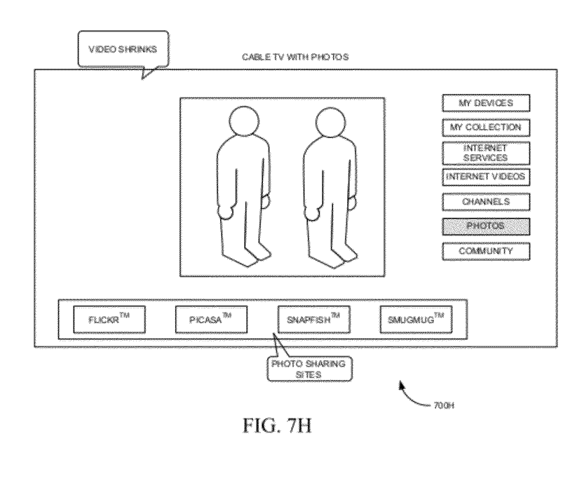

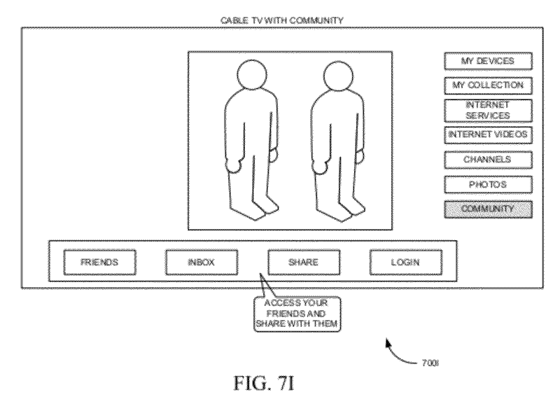

Referring now to FIGS. 7A-7I, screenshots 700A-I showing accessing of main menu and sub-menu of the homepage without overlapping the multi-media content are illustrated, according to one embodiment. Consider a scenario when the user selects the “cable TV set-top box” tab and thereafter selects a program for viewing. While the program is running on the Internet TV, the user presses a menu button on the remote control device, as illustrated in FIG. 7A. In such a case, the present invention displays the main menu on the Internet TV along with the program which the user was already watching, as shown in FIG. 7B. It can be seen from FIGS. 7B-7I that, the Internet TV is capable of displaying the main menu along with the program by shrinking the program. It is appreciated that the already running program and the main menu are displayed in such a manner that overlapping of the multi-media content with the menu is avoided, thereby adhering to the broadcast TV regulations.

FIGS. 7C-7I illustrate screenshots showing accessing of the main menu and associated sub-menu while the program is running on the Internet TV. FIG. 7C shows the shrunk program with the main menu and my devices sub-menu (horizontally at the bottom of the display of the Internet TV) displaying different devices connected to the Internet TV via the device 102. FIG. 7D shows the shrunk program with the main menu and my collection sub-menu selected by the user from the main menu It is appreciated that, the user can access playlists, bookmarks and files from the a USB stick while the program is running, according to the example embodiment illustrated in FIG. 7D. FIG. 7E shows the shrunk program with the main menu and Internet services sub-menu selected by the user from the main menu. It is appreciated that, the Internet services sub-menu displays various services provided by Internet services which are accessed by the user by selecting the icons from the sub-menu.

FIG. 7F shows the shrunk program with the main menu and Internet videos sub-menu selected by the user from the main menu. It can be seen from FIG. 7F that, the Internet videos sub-menu enables the user to access multi-media content by selecting any one of the Internet video services, such as YouTube™, hulu™, VTap™ and abc™ from the sub-menu. FIG. 7G shows the shrunk program with the main menu and the channels sub-menu selected by the user from the main menu. As shown in FIG. 7G, the channels sub-menu enables the user to access the multi-media content upon selection of a channels from the sub-menu.

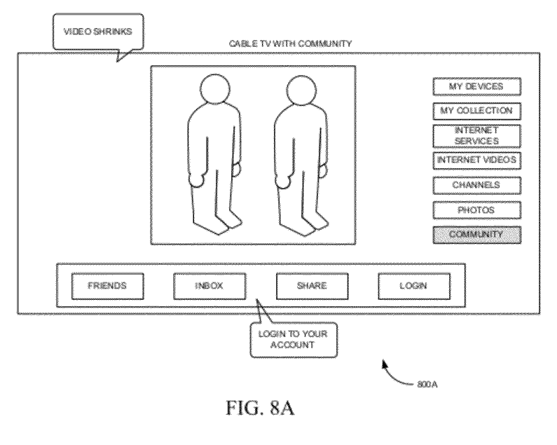

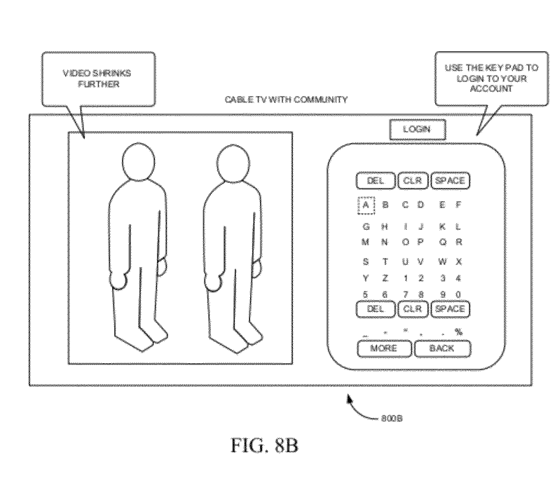

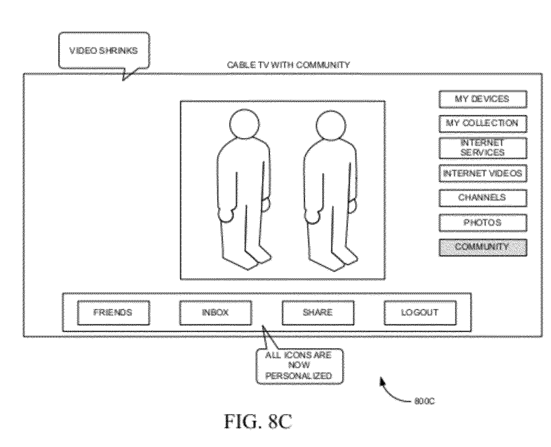

FIG. 7H shows the shrunk program with the main menu and photos sub-menu selected by the user from the main menu. As shown in FIG. 7H, the photos sub-menu enables the user to manage the photos using the photo sharing sites, such as flickr™ Picasa™, snapfish™ and smugmug™ displayed in the photos sub-menu. FIG. 7I shows the shrunk program with the main menu and community sub-menu selected by the user from the main menu. As shown in FIG. 7I, the community sub-menu enables the user to build a community network (access the friends and sharing with them) using the icons in the sub-menu. Further, the accessing of the community sub-menu is described in more detail with respect to FIGS. 8A-8C. It is appreciated that the main menu can be navigated using the up and down arrow key of the Internet TV remote control device and the sub-menu can be navigated using the left and right key of the Internet TV remote control device.

Referring now to FIGS. 8A-8C, screenshots 800A-C showing accessing of a community network while the program is running are illustrated, according to one embodiment. As shown in FIG. 8A, the community sub-menu includes a “friends” tab, an “inbox” tab, a “share” tab and a “login” tab. The user is allowed to access and manage the community network (using the “friends” tab, the “share” tab and the “inbox” tab) upon providing the login information. When a user clicks on the “login” tab, the user is displayed with a keypad for entering the login details as illustrated in FIG. 8B.

[0049]It can be seen from FIG. 8B that, the program which is running while the user selects the “login” tab (as illustrated in FIG. 8A) is further shrunk such that the keypad for obtaining the login details is displayed along with the program without overlapping the multi-media content. Further, once the user provides the correct login information using the keypad displayed on Internet TV, the user is allowed to access his/her community network. In other words, all the tabs are personalized upon login into his/her account, as shown in FIG. 8C. It is appreciated that, the user can access the community network on the Internet TV while the program is being watched.

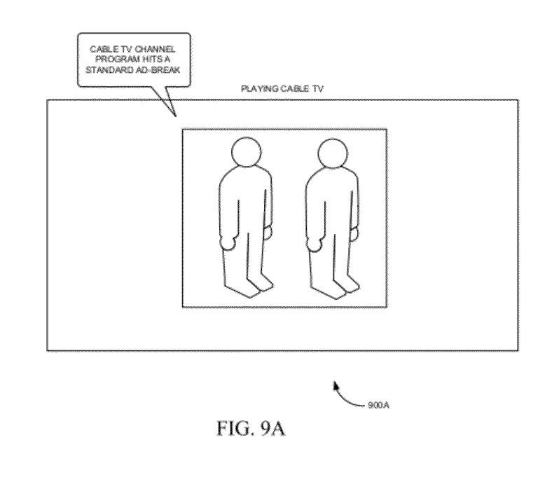

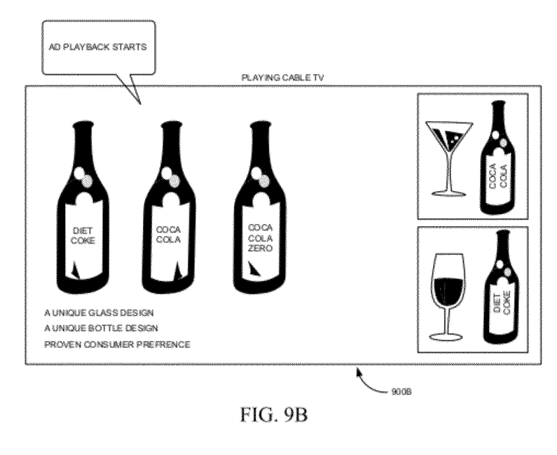

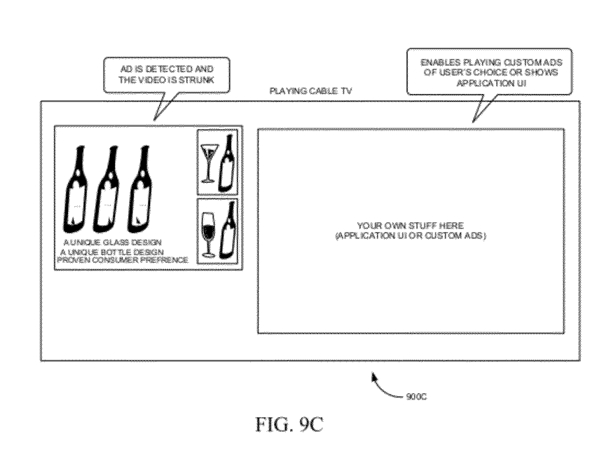

Referring now to FIGS. 9A-9C, screenshots 900A-C showing playing of customized multi-media content when advertisements are being broadcasted are illustrated, according to one embodiment. FIG. 9A illustrates a screenshot of a cable channel program being watched on the Internet TV. Consider a scenario when the program hits back with the standard ad-break. The advertisement associated with the standard ad-break is being displayed on the Internet TV as shown in FIG. 9B. In such a scenario, the device 102 detects the ad-break and the advertisement. Further, the advertisement that is being broadcasted during the ad-break is shrunk and the user is allowed to play custom advertisements of user's choice, according to the example embodiment illustrated in FIG. 9C. In one embodiment, the Internet TV shows an application user interface (UI) if the user does not want to play any ads during the standard ad-break.

A skilled person will recognize that many suitable designs of the systems and processes may be substituted for or used in addition to the configurations described above. It should be understood that the implementation of other variations and modifications of the embodiments of the invention and its various aspects will be apparent to one ordinarily skilled in the art, and that the invention is not limited by the exemplary embodiments described herein. Therefore, it is contemplated to cover the present embodiments of the invention and any and all modifications, variations, or equivalents that fall within the true spirit and scope of the basic underlying principles disclosed herein. The contents of all references cited are incorporated herein by reference in their entireties.

What is claimed is:

1. A device for delivering multi-media content to an Internet television (TV), comprising:
an Internet TV engine configured to couple to one or more Internet devices, wherein the Internet TV engine generates raw uncompressed media data from multi-media streams received from one of the one or more Internet devices;
a digital media receiver configured to couple to one or more digital media devices, wherein the digital media receiver substantially simultaneously generates decrypted digital media content from encrypted digital media content received from one of the one or more digital media devices;
a dual channel digital format video converter coupled to the Internet TV engine and the digital media receiver, wherein the dual channel digital format video converter generates any one of the raw uncompressed media data, the decrypted digital media content and mixed multi-media content by processing the raw uncompressed media data received from the Internet TV engine and/or the decrypted digital media content received from the digital media receiver; and
a digital media transmitter for encrypting and transmitting any one of the raw uncompressed media data, the decrypted digital media content and the mixed multi-media content to the Internet TV via a digital media receiver interface, wherein the raw uncompressed media data and the decrypted digital media content in the mixed multi-media content are displayed on different portions of a display of the Internet TV.

2. The device of claim 1, wherein the Internet TV engine comprises:
a multi-media stream decoder for generating decoded multi-media streams by decoding the multi-media streams received from the one of the one or more Internet devices;
a synchronizer for synchronizing the decoded multi-media streams based on time stamps; and
a re-scaler for generating the raw uncompressed media data by re-scaling resolutions of the synchronized decoded multi-media streams to a same resolution.

3. The device of claim 2, wherein the multi-media stream decoder comprises:
a container format identifier for identifying a container format associated with the received multi-media streams;
an audio-video (A/V) format detector for detecting an A/V format associated with the identified container format of the received multi-media streams and loading at least one of audio decoders, video decoders and A/V decoders based on the detected A/V format; and
a raw data generator for decoding the received multi-media streams using the loaded at least one of the audio decoders, the video decoders and the A/V decoders, and generating the decoded multi-media streams.

4. The device of claim 1, wherein the digital media receiver comprises:
a high-bandwidth digital content protection (HDCP) decryption module for decrypting the received encrypted digital media content.

5. The device of claim 1, wherein the dual channel digital format video converter comprises:
a scaler for generating the raw uncompressed media data and the decrypted digital media content of a same resolution by scaling resolutions of the raw uncompressed media data and the decrypted digital media content received at the dual channel digital format video converter;
a mixer for generating the mixed multi-media content by mixing the raw uncompressed media data and the decrypted digital media content of the same resolution; and
a video switch for switching between the raw uncompressed media data, the decrypted digital media content and the mixed multi-media content based on a request from a user of the Internet TV, wherein the user request is received via a remote control device of the Internet TV.

6. The device of claim 5, wherein the scaler scales the resolutions of the raw uncompressed media data and the decrypted digital media content to a resolution selected from the group consisting of a predetermined range or a fixed resolution.

7. The device of claim 1, wherein the digital media transmitter comprises:
a HDCP encryption module for encrypting any one of the raw uncompressed media data, the decrypted digital media content and the mixed multi-media content received from the dual channel digital format video converter prior to transmitting any one of the raw uncompressed media data, the decrypted digital media content and the mixed multi-media content to the Internet TV.

8. The device of claim 7, wherein the display of the Internet TV is configured to display at least one of a user interface screen and a video playback screen when the encrypted raw uncompressed media data is received by the Internet TV.

9. The device of claim 8, wherein the display of the Internet TV is configured to display a video playback screen when the encrypted digital media content is received by the Internet TV.

10. The device of claim 9, wherein the display of the Internet TV is configured to display the user interface screen associated with the encrypted raw uncompressed media data along with the video playback screen associated with the encrypted digital media content when the encrypted mixed multi-media content is received by the Internet TV, and wherein the user interface screen and the video playback screen are displayed on different portions of the display of the Internet TV.

11. The device of claim 1, wherein the Internet TV engine receives the multi-media streams from the one of the one or more Internet devices selected from the group consisting of a wireless device, an Ethernet based device, and a universal serial bus (USB) device.

12. The device of claim 11, wherein the multi-media streams comprises at least one of audio data, video data and image data.

13. The device of claim 1, wherein the digital media receiver receives the encrypted digital media content from the one of the one or more digital media devices selected from the group consisting of a digital video disc (DVD) player, a playstation, a satellite set-top box, an x box and a cable TV set-top box.

14. The device of claim 1, wherein the encrypted digital media content is having a resolution selected from the group consisting of 480 progressive scan(p), 720 p and 1080 p.

15. A system comprising:
an Internet TV;
one or more Internet devices;
one or more digital media devices; and
a device for delivering multi-media content from one of the one or more Internet devices and one of the one or more digital media devices to the Internet TV, wherein the one or more Internet devices and the one or more digital media devices are coupled to input ports of the device and the Internet TV is coupled to an output port of the device, and wherein the device comprises:
an Internet TV engine configured to couple to the one or more Internet devices, wherein the Internet TV engine generates raw uncompressed media data from multi-media streams received from the one of the one or more Internet devices;
a digital media receiver configured to couple to the one or more digital media devices, wherein the digital media receiver substantially simultaneously generates decrypted digital media content from encrypted digital media content received from the one of the one or more digital media devices;
a dual channel digital format video converter coupled to the Internet TV engine and the digital media receiver, wherein the dual channel digital format video converter generates any one of the raw uncompressed media data, the decrypted digital media content and mixed multi-media content by processing the raw uncompressed media data received from the Internet TV engine and/or the decrypted digital media content received from the digital media receiver; and
a digital media transmitter for encrypting and transmitting any one of the raw uncompressed media data, the decrypted digital media content and the mixed multi-media content to the Internet TV via a digital media receiver interface, wherein the raw uncompressed media data and the decrypted digital media content in the mixed multi-media content are displayed on different portions of a display of the Internet TV.

16. The system of claim 15, wherein the display of the Internet TV is configured to display at least one of a user interface screen and a video playback screen when the encrypted raw uncompressed media data is received by the Internet TV.

17. The system of claim 16, wherein the display of the Internet TV is configured to display a video playback screen when the encrypted digital media content is received by the Internet TV.

18. The system of claim 17, wherein the display of the Internet TV is configured to display the user interface screen associated with the encrypted raw uncompressed media data along with the video playback screen associated with the encrypted digital media content when the encrypted mixed multi-media content is received by the Internet TV, and wherein the user interface screen and the video playback screen are displayed on different portions of the display of the Internet TV.

19. An Internet TV comprising:
a display;
a processor;
memory coupled to the processor and configured to store instructions associated with the Internet TV; and
a device coupled to the processor and configured to receive multi-media streams and encrypted digital media content and to generate any one of raw uncompressed media data, decrypted digital media content and mixed multi-media content, wherein the device comprises:
an Internet TV engine configured to couple to one or more Internet devices, wherein the Internet TV engine generates raw uncompressed media data from the multi-media streams received from one of the one or more Internet devices;
a digital media receiver configured to couple to one or more digital media devices, wherein the digital media receiver substantially simultaneously generates decrypted digital media content from the encrypted digital media content received from one of the one or more digital media devices;
a dual channel digital format video converter coupled to the Internet TV engine and the digital media receiver, wherein the dual channel digital format video converter generates any one of the raw uncompressed media data, the decrypted digital media content and the mixed multi-media content by processing the raw uncompressed media data received from the Internet TV engine and/or the decrypted digital media content received from the digital media receiver; and
a digital media transmitter for encrypting and transmitting any one of the raw uncompressed media data, the decrypted digital media content and the mixed multi-media content to the Internet TV via a digital media receiver interface, wherein the raw uncompressed media data and the decrypted digital media content in the mixed multi-media content are displayed on different portions of the display of the Internet TV.

20. A method of delivering multi-media content to an Internet TV, comprising:
generating raw uncompressed media data from multi-media streams received from one of one or more Internet devices;
substantially simultaneously generating decrypted digital media content from encrypted digital media content received from one of one or more digital media devices;
generating mixed multi-media content by processing the raw uncompressed media data and the decrypted digital media content; and
encrypting and transmitting any one of the raw uncompressed media data, the decrypted digital media content and the mixed multi-media content to the Internet TV through a digital media receiver interface, wherein the mixed multi-media content is generated such that the raw uncompressed media data and the decrypted digital media content in the mixed multi-media content are displayed on different portions of a display of the Internet TV.

21. The method of claim 20, further comprising:
generating decoded multi-media streams by decoding the received multi-media streams;
synchronizing the decoded multi-media streams based on time stamps; and
re-scaling resolutions of the synchronized decoded multi-media streams to a same resolution for generating the raw uncompressed media data.

22. The method of claim 21, wherein generating the decoded multi-media streams by decoding the received multi-media streams comprises:
identifying a container format associated with the received multi-media streams;
detecting an audio-video (AN) format associated with the identified container format of the received multi-media streams;
loading at least one of audio decoders, video decoders and A/V decoders based on the detected A/V format; and
decoding the received multi-media streams using the loaded at least one of audio decoders, video decoders and A/V decoders.

23. The method of claim 20, wherein processing the raw uncompressed media data and the decrypted digital media content comprises:
generating the raw uncompressed media data and the decrypted digital media content of a same resolution by scaling resolutions of the raw uncompressed media data and the decrypted digital media content;
generating the mixed multi-media content by mixing the raw uncompressed media data and the decrypted digital media content of the same resolution; and
switching between the raw uncompressed media data, the decrypted digital media content and the mixed multi-media content based on a request from a user of the Internet TV, wherein the user request is received via a remote control device of the Internet TV.

24. The method of claim 23, further comprising:
encrypting any one of the raw uncompressed media data, the decrypted digital media content and the mixed multi-media content prior to transmitting any one of the raw uncompressed media data, the decrypted digital media content and the mixed multi-media content to the Internet TV.

25. The method of claim 24, further comprising:
displaying at least one of a user interface screen and a video playback screen on the display of the Internet TV when the encrypted raw uncompressed media data is received by the Internet TV.

26. The method of claim 25, further comprising:
displaying a video playback screen on the display of the Internet TV when the encrypted digital media content is received by the Internet TV.

27. The method of claim 26, further comprising:
displaying the user interface screen associated with the encrypted raw uncompressed media data along with the video playback screen associated with the encrypted digital media content when the encrypted mixed multi-media content is received by the Internet TV, wherein the user interface screen and the video playback screen are displayed on different portions of the display of the Internet TV.

28. The method of claim 20, wherein in generating the raw uncompressed media data, the one of the one or more Internet devices is selected from the group consisting of a wireless device, an Ethernet based device, and an universal serial bus (USB) device.

29. The method of claim 20, wherein the multi-media streams comprises at least one of audio data, video data and image data.

30. The method of claim 20, wherein in generating the decrypted digital media content, the one of the one or more digital media devices is selected from the group consisting of a digital video disc (DVD) player, a playstation, a satellite set-top box, an x box, and a cable TV set-top box.
